(19) United States
(12) Patent Application Publication
(10) Pub. No.: US 2005/0184861 A1
(43) Pub. Date: Aug. 25, 2005

(54) Programmable transmission sensor

(76) Inventor: Robert Shane Scott, White House, TN (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 11/057,336

(22) Filed: Feb. 11, 2005

Related U.S. Application Data
(60) Provisional application No. 60/544,083, filed on Feb. 12, 2004.

(51) Int. Cl. B60Q 1/00

(52) U.S. Cl. 340/441

(57) ABSTRACT

A programmable sensor for use with the transmission and speedometer of a motor vehicle is provided whereby accurate speedometer readings are obtained which reflect changes in the transmission of the motor vehicle.

This non-provisional application claims the benefit of U.S. Provisional Application Ser. No. 60/544,083, filed Feb. 12, 2004.

### TECHNICAL FIELD

The present invention relates to a programmable sensor for use with the transmission and speedometer of a motor vehicle. In a more specific aspect, this invention relates to a programmable sensor for use with the transmission and speedometer of a motor vehicle to obtain accurate speedometer readings.

Although especially adapted for use with motorcycles, this invention can also be used with other types of motor vehicles, such as motor bikes, automobiles and motor scooters.

### BACKGROUND OF THE INVENTION

In motor vehicles, a common problem which has existed for some time is a speedometer reading which is not accurate. Quite clearly, an inaccurate speedometer reading can negatively affect many things related to a motor vehicle, such as perception of performance, calculations of mileage results, increased chance of a moving violation, increased risk of danger, etc.

Many events can affect the speedometer reading of a motor vehicle. Examples of such events include changes in transmission speeds, tire sizes, pulley changes and gear ratio changes. Motor vehicles have a factory-installed sensor which works in relation to the transmission to reflect a speedometer reading. However, the factory-installed sensor does not work in relation to the transmission to reflect new speedometer readings in view of changes to the motor vehicle, such as the changes mentioned above.

Consequently, there is a need in the motor vehicle industry for a device which will replace the factory-installed sensor and which will successfully and consistently enable a person to obtain an accurate speedometer reading in view of various changes to that person's motor vehicle.

### SUMMARY OF THE INVENTION

Briefly described, the present invention provides a programmable sensor for use with the transmission and speedometer of a motor vehicle. In general terms, the sensor receives a signal from the transmission and then sends a signal to the speedometer, which enables the speedometer to correct, as necessary, to an accurate reading.

Accordingly, an object of this invention is to provide a programmable sensor for use with the transmission and speedometer of a motor vehicle.

Another object of this invention is to provide a programmable sensor for use with the transmission and speedometer of a motor vehicle to obtain an accurate speedometer reading.

Another object of this invention is to provide a programmable sensor which transmits an electronic signal from the transmission of a motor vehicle to the speedometer to obtain an accurate speedometer reading.

These and other objects, features and advantages of this invention will become apparent from the following detailed description.

### BRIEF DESCRIPTION OF THE DRAWINGS

FIG. 1 is a front view of a preferred embodiment of a programmable sensor according to this invention.

FIG. 2 is a back view of a preferred embodiment of a programmable sensor according to this invention.

### DETAILED DESCRIPTION OF THE INVENTION

The present invention provides a programmable sensor for use in a motor vehicle to provide the user of that motor vehicle with an accurate speedometer reading.

The programmable sensor of this invention is comprised of (a) a microprocessor for receiving a signal from the transmission of a motor vehicle and then converting that signal to a signal readable by the speedometer of that motor vehicle; (b) a housing which contains the microprocessor, wherein the housing includes an electronic display and means for activating and deactivating the sensor; and (c) means for connecting the sensor to the transmission and speedometer of the motor vehicle.

In a preferred embodiment of this invention, the electronic display is accomplished through a light emitting diode, and the signals from the transmission to the sensor and from the sensor to the transmission are electronic.

The sensor of this invention is programmable to apply a percentage correction factor to the gear tooth signal which feeds the speedometer, and the range of correction factors is from about −50 percent to about +50 percent.

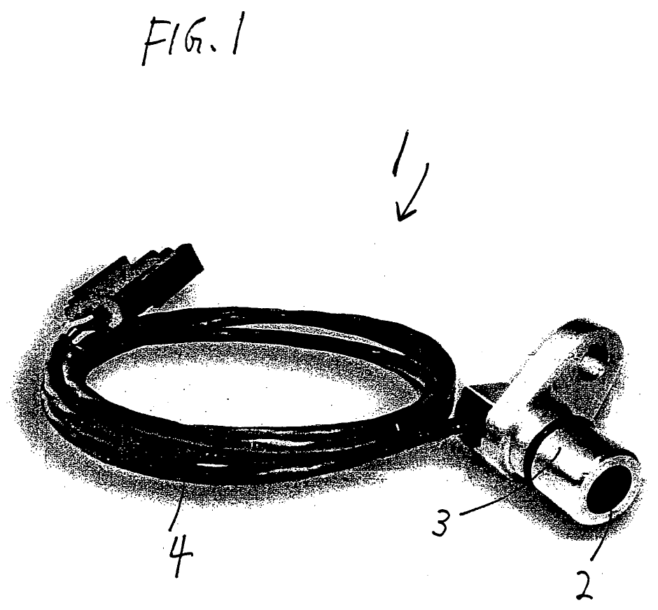

Referring now to the drawings, in which like numbers represent like elements. FIG. 1 shows a front view of a preferred embodiment of the sensor of this invention. Sensor 1 is shown with sensor face 2 (i.e., the reading face of the sensor) and a microprocessor (not shown) located inside housing 3. Sensor 1 is connected to a transmission (not shown) and to a speedometer (not shown) through connecting means 4. An electronic signal is received from the transmission by the microprocessor and then converted to an electronic signal which is readable by the speedometer which, as necessary, reacts to provide an accurate speedometer reading.

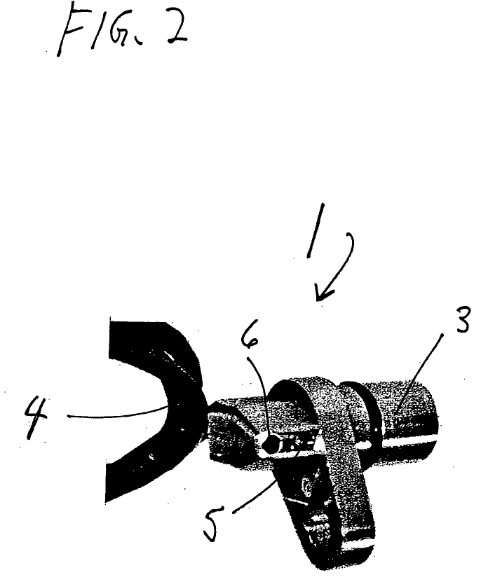

FIG. 2 shows a back view of a preferred embodiment of this invention. Sensor 1 is shown with housing 3 which contains a microprocessor (not shown), pushbutton means 5 for activating/deactivating sensor 1 and LED display 6.

The present invention is further illustrated by the following examples which are illustrative of certain embodiments designed to teach those of ordinary skill in the art how to practice this invention and to represent the best mode contemplated for practicing this invention.

### EXAMPLE 1

A motorcycle user replaces his 64 tooth rear pulley with a 72 tooth pulley. As his motorcycle is equipped with a factory-installed sensor, the speedometer will now read slower than true speed. This error can be calculated using the following equation:
Error=1−(new pulley/old pulley)×100
or
Error=1−(72/64)×100=12.5%

Rounding up, the speedometer will read 13% slower than true speed, so the correction factor is +13 for an accurate speedometer reading.

### EXAMPLE 2

A motorcycle user replaces his 28 ″ rear tire with a 29″ tire. Based on the factory-installed sensor on his motorcycle, the speedometer will now read faster than true speed. This error can be calculated using the following equation:
Error=(new tire height/old tire height)−1×100
or
Error=(29/28−1)×100=3.5%

Rounding up, the speedometer will read 4% faster than true speed, so the correction factor is −4 for an accurate speedometer reading.

The correction factors determined in Examples 1 and 2 are programmed into the sensor through the pushbutton and LED display. To enter the program mode of the sensor, the pushbutton is held down with the power off, and then the sensor is powered with 9-12 volts across the connecting means. At this point, the LED will begin to slowly blink.

To input a positive correction factor (Example 1), release the pushbutton while the LED is in the on mode. To input a negative correction factor (Example 2), release the pushbutton while the LED is in the off mode. After the pushbutton is released, the LED will begin to rapidly blink, which indicates that the sensor will accept a correction factor.

To input a correction factor, the pushbutton should be pushed once for each percentage correction. (For example, for a 5% correction factor, the pushbutton should be pushed 5 times.) The LED will blink each time the pushbutton is pushed, after which the LED will resume blinking. After the pushbutton is pushed for the last time, the sensor will continue to blink for several seconds and then burn the correction factor into memory.

In a preferred embodiment of this invention, the sensor will use the LED to “echo back” the programmed correction factor to ensure that the proper factor has been programmed. This echo sequence starts immediately after the rapid blinking of the LED stops.

For a positive correction factor, the LED will blink once for each percent of correction. If that factor is programmed, the LED will blink 4 times before going dark. For a negative correction factor, the LED will blink in the on mode for a long period of time before blinking once for each percent of correction. (For example, for a negative correction factor of 3, the LED will blink one long pulse, then blink 3 short pulses.)

After these events have occurred, the sensor is ready for normal use.

This invention has been described in detail with particular reference to certain embodiments, but variations and modifications can be made without departing from the spirit and scope of the invention.

1. A programmable sensor for a motor vehicle having a transmission and a speedometer, wherein the sensor comprises:
A. a microprocessor adapted to receive a first signal from the transmission and to convert the first signal to a second signal readable by the speedometer, wherein the first and second signals reflect changes in the transmission;
B. a housing for the microprocessor, wherein the housing includes an electronic display and means for activating and deactivating the sensor; and
C. means for placing the sensor in a connectional relationship with the transmission and with the speedometer;
wherein the speedometer reads the second signal and adjusts to reflect changes in the transmission.

2. A programmable sensor as defined by claim 1 wherein the electronic display is accomplished through a light emitting diode.

3. A programmable sensor as defined by claim 1 wherein the first signal is electronic.

4. A programmable sensor as defined by claim 1 wherein the second signal is electronic.

5. A programmable sensor as defined by claim 1 wherein the means for activating and deactivating the sensor is a pushbutton means.

6. A programmable sensor as defined by claim 1 wherein the sensor is programmable to apply a percentage correction factor to a gear tooth signal in the speedometer.

7. A programmable sensor as defined by claim 6 wherein the percentage correction factor is from about −50 percent to about +50 percent.

8. A process for adjusting a speedometer in a motor vehicle to reflect changes in a transmission of the motor vehicle, wherein the process comprises the steps of:
A. sending a first signal to a programmable sensor to reflect changes in the transmission, wherein the sensor is in a connectional relationship with the transmission and with the speedometer;
B. using a microprocessor to convert the first signal to a second signal readable by the speedometer;
wherein the speedometer reads the second signal and adjusts to reflect changes in the transmission.

9. A process as defined by claim 8 wherein the electronic display is accomplished through a light emitting diode.

10. A process as defined by claim 8 wherein the first signal is electronic.

11. A process as defined by claim 8 wherein the second signal is electronic.

12. A process as defined by claim 8 wherein the sensor is programmable to apply a percentage correction factor to a gear tooth signal in the speedometer.

13. A process as defined by claim 12 wherein the percentage correction factor is from about −50 percent to about +50 percent.
